(19) United States
(12) Patent Application Publication
(10) Pub. No.: US 2007/0132722 A1
(43) Pub. Date: Jun. 14, 2007

(54) Hand interface glove using miniaturized absolute position sensors and hand interface system using the same

(75) Inventors: Yong Wan Kim, Taejon (KR); Yongseok Jang, Seoul (KR); Wookho Son, Taejon (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/588,221

(22) Filed: Oct. 27, 2006

(30) Foreign Application Priority Data
Dec. 8, 2005 (KR) 2005-0119828
Aug. 10, 2006 (KR) 2006-0075783

(51) Int. Cl. G09G 5/00

(52) U.S. Cl. 345/156

(57) ABSTRACT

A hand interface glove using a miniaturized absolute position sensor and a hand interface system using the same for allowing a user to naturally interact with a virtual environment are provided. The hand interface glove includes a glove unit formed in a shape of a hand to be worn by a hand; a sensor unit for sensing analog signals representing absolute positions of finger joints, which change according to motions made by the finger joints, by disposing a plurality of miniaturized absolute sensors tracking the absolute positions of finger joints at predetermined positions of the glove unit corresponding to finger joints; and a data collecting unit for receiving the sensed analog signals from the sensing unit, transforming the analog signals to digital signals through amplifying and filtering the received analog signals, and outputting the digital signals.

### BACKGROUND OF THE INVENTION

1. Field of the Invention

The present invention relates to a system for interacting with a virtual environment using a hand interface, and more particularly, to a hand interface grove using a miniaturized absolute position sensor and a hand interface system using the same for allowing a user to naturally interact with a virtual environment by finely and delicately controlling a virtual hand model in a cyberspace through tracking the motions of hand in a real space.

2. Description of the Related Art

A hand interface technology is an interface technology related to an interaction between the hands of human and objects in a cyberspace. The hand interface technology provides a deeper immersion sense to a user by complementing visual and auditive special effects. Such a hand interface technology has been popularly used in a game industry and a virtual medical field. However, the hand interface technology has been seldom applied to manufacture products.

A virtual reality technology has been applied to manufacture automobiles and vessels in order to overcome the problems in high cost and low efficiency. Recently developed virtual reality technology is a low-level virtual technology that only provides simple visual information. However, there were many difficulties arisen to apply a technology which allows a user to interact with objects in cyberspace using tactual sense into a manufacturing industry in a view of usability and accuracy.

Therefore, a virtual reality technology for manufacturing products must be developed to be accurate and convenient enough to be applied into the real processes for manufacturing products. That is, the virtual reality technology must make a user to feel touching a real object, and make fine hand motions to be interacted with objects in cyberspace.

Therefore, the virtual reality technology for the manufacturing industry required a realistic hand interface apparatus that allows accurate and fine interaction between user's motions in a real space and objects in cyberspace without giving inconvenience to a user as a highly precision interaction technology using tactual sense.

A conventional hand interface technology was introduced in US Patent Publication No. 2004/0164880, entitled “wearable data input device employing wrist and finger movements.” The wearable data input device detects positions of keys in a keyboard using a switch type sensor for sensing motions made by wrists and fingers. Such a wearable data input device was developed to replace a typical keyboard. However, the wearable data input device cannot measure multi-finger joints to sense fine motions of fingers and cannot guarantee high accuracy. Also, calibration is very complicated.

As another related conventional technology, a method for tracking motions by attaching flexible resistive sensors at joints of hands and human body was introduced in U.S. Pat. No. 6,937,033, entitled “Position Sensor with Resistive Element.” It related to the principle and implementing method for a displacement sensor. However, it cannot be applied to an environment requiring high reality such as design, criticism, and assemble because it is greatly influenced by variation of finger length, position, humidity and temperature.

As another related conventional technology, U.S. Pat. No. 6,701,296, entitled “Strain-sensing Goniometer, System and Recognition Algorithms”, introduced a glove type interface that senses resistance variation using flexible resistive sensors attached at fingers when fingers are bended. It also has a problem that calibration is frequently required because it is greatly influenced by variation of finger length, position, humidity and temperature.

Another related conventional technology was introduced in U.S. Pat. No. 7,012,593, entitled “Glove-type Data Input Device and Sensing Method Thereof.” It is for inputting data in a keyboard or a portable phone by detecting variation of the shape or the distance of the glove changing according to the user's finger movements and sensing the level of pressure sensed from at least one of contact surfaces. It advantageously provides easy data input mechanism to a small terminal. However, it cannot support simulation that requires highly accurate finger movement to be sensed, such as the virtual design, criticism, and assemble of a predetermined product.

### SUMMARY OF THE INVENTION

Accordingly, the present invention is directed to a hand interface glove using miniaturized absolute position sensors and a hand interface system using the same, which substantially obviates one or more problems due to limitations and disadvantages of the related art.

It is an object of the present invention to provide a hand interface glove using miniaturized absolute position sensors and a hand interface system using the same for providing natural hand motions in a cyberspace by accurately and finely matching user's hand motion in real space to virtual hand motion in a cyber space through interacting a virtual hand model with an object in a cyberspace by controlling the virtual hand model through measuring the absolute positions of fingerjoints using miniaturized absolute position sensors.

It is another object of the present invention to provide a hand interface glove using miniaturized absolute position sensors and a hand interface system using the same for providing realistic virtual experience to a user to criticize a car in a cyberspace, such as taking a wheel, pushing buttons in a gauge board, operating a gear stick, and holding a door knob in a “car virtual criticize scenario” by supporting a natural hand interface that is highly matched to a real space.

It is a further another object of the present invention to provide a hand interface glove using miniaturized absolute position sensors and a hand interface system using the same for performing a simple compensating operation based on simple hand motions of a setting operation according to a size of user in an operation for accurately tracking user's hand motion using miniaturized absolute position sensors that measures absolute positions of fingerjoints.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a hand interface glove using miniaturized absolute position sensors including: a glove unit formed in a shape of a hand to be worn by a hand; a sensor unit for sensing analog signals representing absolute positions of finger joints, which change according to motions made by the finger joints, by disposing a plurality of miniaturized absolute sensors tracking the absolute positions of finger joints at predetermined positions of the glove unit corresponding to finger joints; and a data collecting unit for receiving the sensed analog signals from the sensing unit, transforming the analog signals to digital signals through amplifying and filtering the received analog signals, and outputting the digital signals.

The miniaturized absolute position sensors may sense the absolute positions of fingerjoints by detecting variation of a length of a fine wire that is inserted into an embedded coil, where the length of fine wire varies according to the absolute position of finger joint. The miniaturized absolute position sensors may be attachable/detachable to/from a surface of the glove unit.

In another aspect of the present invention, there is provided a hand interface system using miniaturized absolute position sensors including: a hand interface hardware for sensing absolute position signals of finger joints by disposing miniaturized absolute position sensors sensing absolute positions of finger joints at predetermined positions of a glove worn by a hand corresponding to finger joints, and transferring the sensed absolute position signals; and a hand interface software for controlling a motion of a virtual hand model by calculating an angle of each finger joint using the sensed absolute position signals of finger joints transferred from the hand interface hardware, and controlling interaction between the virtual hand model and objects in a virtual environment.

The miniaturized absolute position sensors may sense the absolute positions of finger joints by detecting variation of a length of a fine wire that is inserted into an embedded coil, where the length of fine wire varies according to the absolute position of finger joint. The hand interface hardware may include a data collecting unit for transforming the sensed absolute position signals to digital signals of each finger joint.

The hand interface software may include: a hand interface management unit for storing a maximum voltage and a minimum voltage of each finger joint, and sensing joint angles of a user and compensating variation of displacement distance which varies according to a size of user's body using the stored maximum and minimum voltages; and a hand interface API for controlling motions of a virtual hand model by calculating joint angles of each finger joint using the transferred absolute position signals of each finger joint, and controlling interaction between the virtual hand model and objects in a virtual environment.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a block diagram illustrating a hand interface system using miniaturized absolute position sensor according to an embodiment of the present invention;

FIG. 2A is a view showing a hand interface hardware according to an embodiment of the present invention;

FIG. 2B is a view showing a miniaturized absolute position sensor;

FIG. 2C is a circuit diagram of a miniaturized absolute position sensor for illustrating the operating principle thereof,

FIG. 3 is a block diagram illustrating a hand interface management according to an embodiment of the present invention; and

FIG. 4 is a block diagram illustrating a hand interface API according to an embodiment of the present invention.

### DETAILED DESCRIPTION OF THE INVENTION

Reference will now be made in detail to the preferred embodiments of the present invention, examples of which are illustrated in the accompanying drawings.

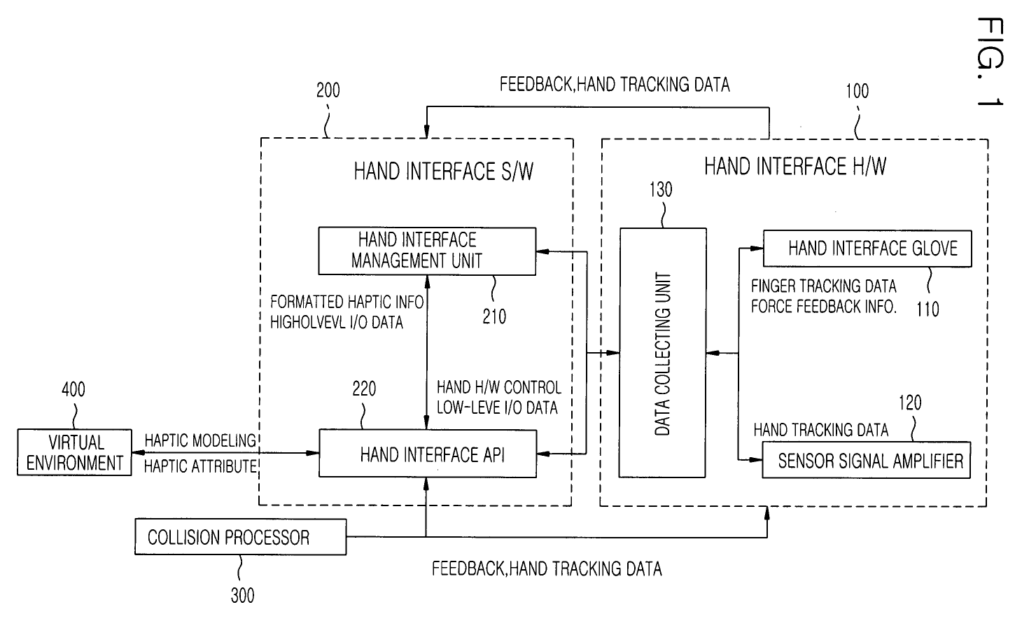

FIG. 1 is a block diagram illustrating a hand interface system using miniaturized absolute position sensor according to an embodiment of the present invention.

Referring to FIG. 1, the hand interface system using miniaturized absolute position sensor includes a hand interface hardware 100 for sensing the motions of the fingers, and a hand interface software 200 for interacting a user with objects in a cyber space using the sensed motions of the fingers.

The hand interface hardware 100 includes miniaturized absolute position sensors disposed at the predetermined positions of a glove corresponding to finger joints to measure the absolute position of the finger joints. The hand interface hardware 100 senses the absolute position signal of each finger joint and transmits the sensed absolute position signal.

The hand interface hardware 100 includes a hand interface glove 110, a sensor signal amplifier 120, and a data collecting unit 130.

The hand interface glove 110 has a form of a typical glove. The hand interface glove 110 includes miniaturized absolute position sensors for sensing the motion of the finger joints and generating tracking information of the finger joint motions. The hand interface glove 110 transmits analog signals sensed from the miniaturized absolute position sensors to the data collecting unit 130.

The sensor signal amplifier 120 amplifies the analog signal generated from the hand interface glove 110.

The data collecting unit 130 receives the analog signals sensed by the miniaturized absolute position sensors. That is, the data collecting unit 130 receives the analog signals as many as the number of the miniaturized absolute position sensors. The miniaturized absolute position sensors disposed at the hand interface glove 110 measures the movements of finger joints, and they are disposes at positions corresponding to the first joint and the second joint of each finger. That is, one hand interface glove 110 includes ten miniaturized absolute position sensors. Therefore, the data collecting unit 130 receives analog signals from twenty miniaturized absolute position sensors.

The data collecting unit 130 transforms the received analog signals to desired level digital signals through amplifying and filtering the received analog signals. The miniaturized absolute position sensors interface with the data collecting unit 130 through a connector.

A computer may display sampling signals inputted through a card type data collecting unit 130 as sensor data. The computer transfers the data received from the miniaturized absolute position sensors to the hand interface software 200 running on the computer through a window based operating system designed with VISUAL C++.

The hand interface software 200 controls the motions of virtual hand models by calculating the angles of finger joints using the absolute position signals of each finger joint transmitted from the hand interface glove 110, and controls the interaction between the virtual hand models and objects in the cyber space.

The hand interface software 200 includes a hand interface management unit 210 and a hand interface API 220.

The hand interface management unit 210 stores a minimum voltage and a maximum voltage measured for linear-transforming voltage values generated from a plurality of miniaturized absolute position sensors in response to the bending motion of fingers, and stores the maximum bending region of each finger to a window register.

The hand interface management unit 210 is independent software from the hand interface API 220.

The hand interface management unit 210 performs a precision compensating operation through monitoring a hand interface, device information and states, and displaying virtual hand models. The hand interface management unit 210 also monitors the states of connection between devices, and the states of sensors.

The hand interface management unit 210 compensates the variation of displacement distances, which changes according to the size of user's body. The hand interface management unit 210 compensates the variation of displacement distance using two hand motions that are used for obtaining accurate initial value of each finger during initializing interface. The simple two hand motions includes one motion that making a fist with a thumb stretched and the other motion that spreading out fingers with a thumb bended. Using the two simple hand motions, voltage values in the maximum and minimum bending ranges of finger joints can be obtained. Since the minimum and maximum displacement values of the thumb cannot be accurately obtained with the fist made, four fingers are bended at different time compared to the thumb. The voltage values generated from the twenty sensors after the first motion is made and another voltage values generated from the twenty sensors after the second motion is made are stored in the registries.

Based on the stored maximum and minimum voltage values for each finger, the angle of finger joints bended by a user is calculated using following Eq. 1.
Angleₜ(i)=(Vₜ(i)−Vₘᵢₙ(i))/(Vₘₐₓ(i)−Vₘᵢₙ(i))×Angleₘₐₓ(i) Eq. 1

In Eq. 1, Angleₜ(i) denotes an angle of i^{th} finger joint when a user bends the i^{th} finger joint at a predetermined angle, Vₘₐₓ(i) is a voltage value when a user maximally bends the i^{th} finger joint, Vmin (i) is a voltage value when a user minimally bends the i^{th} finger joint, and Angleₘₐₓ(i) denotes the maximum and minim bending range of the i^{th} finger joint. Angleₘₐₓ(i) can be adjusted according to a user's hand through a GUI of the hand interface management unit 210. The angle made by the first and second joints is directly obtained by disposing the sensors thereto, and the angle of the third joint is predicted through human anatomical motion structure. Since the third finger joint moves almost similar to the second finger joint, the motion of the third finger joint is predicted through mapping to the second angle. Using such a fact, the number of sensors is advantageously reduced in the present invention. Therefore, sufficient data bandwidth can be obtained and the manufacturing cost can be reduced.

The hand interface system according to the present embodiment includes a function that provides various views with different angles using a virtual hand model that expresses smooth finger joints through applying a variable skin transforming scheme for realistic and accurate hand interface compensating operation. Therefore, a user is allowed to finely control the virtual hand model through directly comparing the finger joint angles.

The hand interface API 220 controls the motion of the virtual hand model by calculating the angles of finger joints using the absolute position signal of each finger joint transmitted from the sensors, and controls the interaction between the virtual hand model and the objects in the cyber space 400.

The hand interface API 220 supports device initialization, device connection, and input/output data streaming for allowing a virtual reality application program to integrally operate the hand interface system. The hand interface API 220 is a PC based library that can be easily integrated to various applications. The hand interface API 220 loads initialization values for initializing sensors and finger joint angle, and provides all functions for calculating finger joint angles based on the voltage values of fingerjoints measured through the data collecting unit 130. Also, the hand interface API 220 is provided as a program library, and it is used through linking while compiling for allowing the virtual reality application program to call functions.

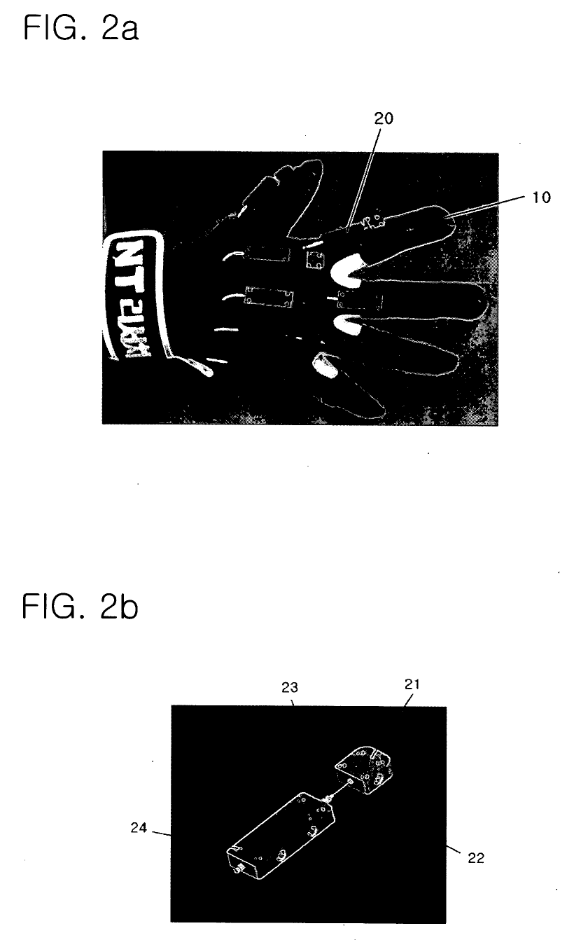

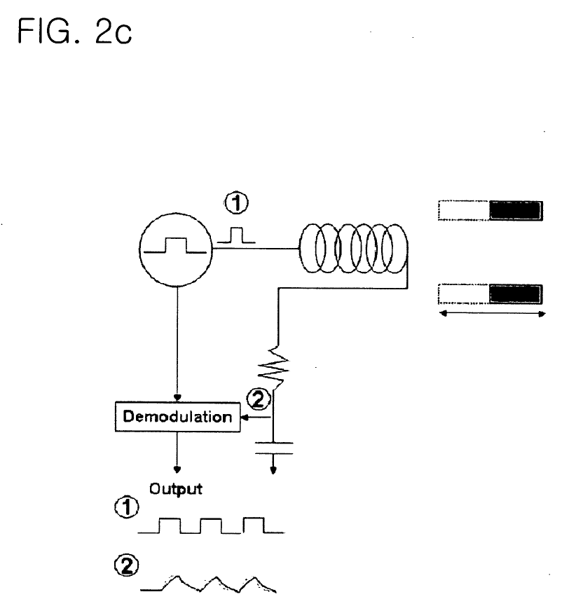

FIG. 2A is a view showing a hand interface hardware according to an embodiment of the present invention, FIG. 2B is a view showing a miniaturized absolute position sensor, and FIG. 2C is a circuit diagram of a miniaturized absolute position sensor for illustrating the operating principle thereof.

The hand interface hardware 100 is hardware equipment including a hand shaped glove 10 and miniaturized absolute position sensors 20 for accurately tracking the shape of hand. For example, two miniaturized absolute position sensors are disposed at one finger. Total 10 sensors may be disposed at one glove. The miniaturized absolute position sensors 20 of the hand interface hardware 100 are devices for measuring the variation of straight line distance changed by displacement. The length of a wire 22 inserted into a fixing unit 24 having a coil changes according to the absolute position of the finger joints, and the wave form of the pulse wave supplied to the coil changes corresponding to the length of the inserted wire 22. Such a variation of wave form is measured to obtain the absolute displacement of the filter joints. The principle of changing of pulse waveform according to the length of the inserted wire 22 is shown in the circuit of FIG. 2C.

As shown in FIG. 2A, the miniaturized absolute position sensor 20 includes a fixing unit 24 and a moving unit 21. The fixing unit 24 and the moving unit 21 are attached on the glove with a finger joint interposed. The one end of the moving unit 21 includes a wire 22 inserted to a coil embedded in the fixing unit 24 according to the absolute position of finger joint. The fixing unit 24 includes the coil. When the wire 22 is inserted into the coil, the fixing unit 24 senses the absolute position of finger joint by detecting variation of the wave form of a supplied pulse wave. Then, the sensed analog signal is transmitted to the data collecting unit 130.

The hand interface hardware 100 uses a linear variable differential transducer (LVDT) type position sensor that transforms a mechanical displacement to an electric signal. The LVDT is a transducer that changes mutual inductance, which is the variation of magnetic flux induced from the first coil to the second coil according to the movement of core. That is, the LVDT generates electric outputs in proportion to the variation of the core that is mechanically and electrically separated and movable. The output of the LVDT senses the amplitude of the induced current generated from the inside coil according to the input position of the core and transforms the sensed amplitude to strain. Also, the output of the LVDT has accurate linear property.

Such a LVDT absolute position sensor is widely used in an inspecting device, semiconductor manufacturing equipment, robots, and medical equipment. However, the LVDT absolute position sensor was not used to measure the displacement of the finger joints as attachable fashion due to its size. If the LVDT absolute position sensor is miniaturized to measure the displacement of human's finger joints, the disadvantages of conventional resistive or optical type sensors, such as degradation of stability due to variation of external environment can be overcome. That is, it the miniaturized absolute position sensor is directly used to measure the angle of finger joints by copying human's finger joints and muscles, the uniformity of measured value can be guaranteed although users' sizes are different from one another. Therefore, additional calibrations are not required according to the users' sizes. Also, a LVDT type absolute position sensor capable of precision tracking with about 4 kHz update rate and 12 bit resolution can be used to high precision hand interface.

Since the motion of the finger joints are not directly measured in the conventional sensing methods, the accuracy and the efficiency of tracking are degraded. Therefore, the convention method is required to perform the compensating operation according to non-intuitive adjusting value when the compensating operation is performed according to the user's size.

However, since the absolute position sensor finely measures displacement according to the intuitive adjusting value, the hand interface system according to the present embodiment is not required to frequently perform the compensating operation, theoretically.

When a conventional absolute position sensor is attached at a glove surface, a wire may be out of a track if the maximum bending exceeds the wire's maximum displacement according to the size of user's finger. In order to overcome such a shortcoming of the conventional LVDT sensor, a soft plastic resin guide may be extended at the end of a pipe so as to minimize the possibility of the wire to be out of the track.

The wire is continuously bended if the finger joints are measured through a contacting scheme. Therefore, it requires sensors to be frequently replaced or repaired due to deterioration of the sensors. If the sensors are fixed at the surface of the glove, it may difficult to separate the sensor from the glove for repair. Therefore, in the present invention, the sensors may be provided as attachable/detachable to/from the glove for overcoming the shortcoming of the sensors fixed at the glove.

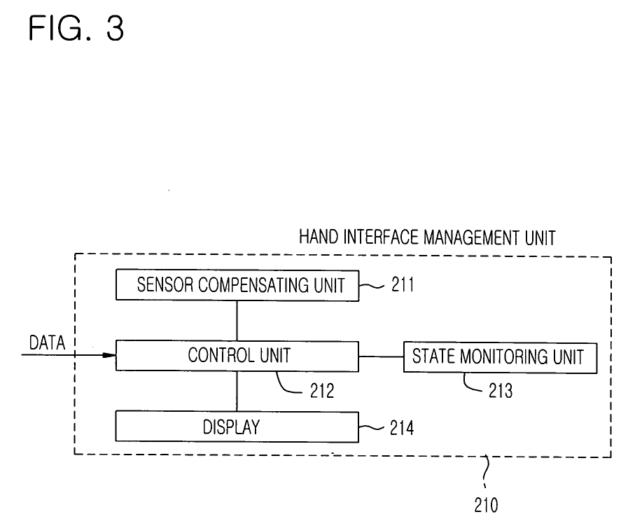

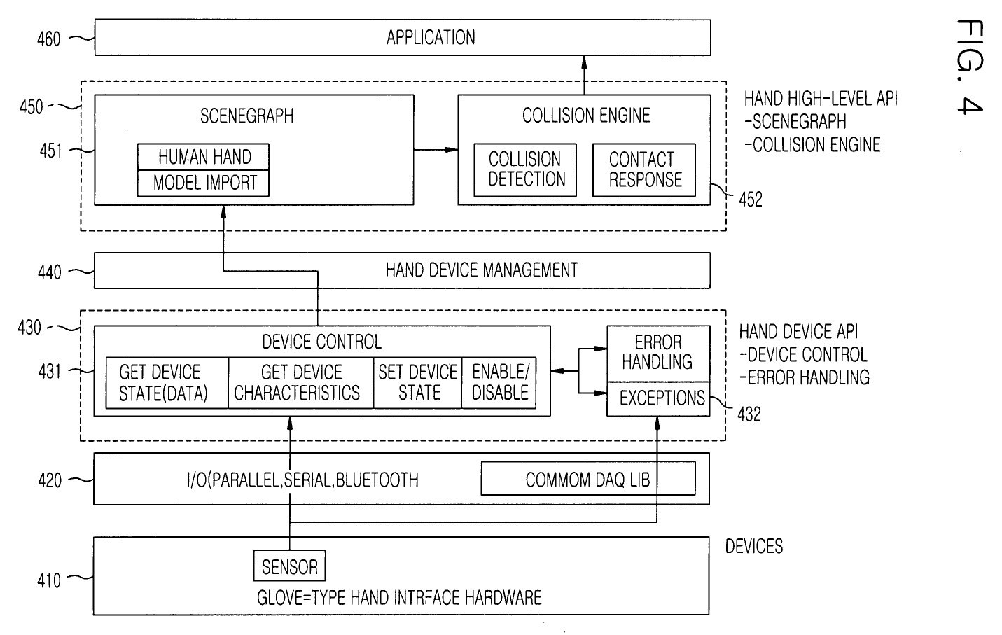

FIG. 3 is a block diagram illustrating a hand interface management according to an embodiment of the present invention.

The hand interface management unit 210 includes a control unit 212, a sensor compensating unit 211, a state monitoring unit 213, and a display 214.

The sensor compensating unit 211 compensates a displacement distance varied according to the size of user's body. The varied displacement distance is compensated according to predetermined hand motions that are used for obtaining accurate initial values for each finger when the initialization is performed.

The state monitoring unit 213 monitors the connection state of each device, and the states of sensors.

The display 214 displays a virtual hand model in graphic to help a user to match a real hand interface with the virtual hand model.

The control unit 212 controls hand interface device information, state monitoring and compensating operation, and controls the sensor compensating unit 211, the state monitoring unit 213 and the display 214.

FIG. 4 is a block diagram illustrating a hand interface API according to an embodiment of the present invention.

Referring to FIG. 4, the hand interface API 220 is a PC based library that can be easily integrated to various applications. The hand interface API 220 supports device initialization and device connection and device input/output data streaming to allow a virtual reality application program to easily and integrally operate the hand interface hardware 100.

The hand interface API 220 loads sensor initial values and finger joint range initial values from registries, and provides all functions for calculating the angles of finger joints based on voltage values of each finger joint obtained through the data collecting unit 130. Also, the hand interface API 220 is provided as a programming library type. Therefore, the hand interface API 220 is linked to the virtual reality application program so as to allow the virtual reality application program to call the functions of the hand interface API 200.

In more detail, the hand interface API 220 includes a hand high level API 450, and a hand device API 430. The hand device API 430 initializes the data collecting unit 130 and the sensor data for managing the hand interface hardware in order to guarantee the hand interface hardware to be correctly operated. A device control module 431 fetches the hand interface sensor data of the data collecting unit from a buffer, and also fetches maximum and minimum resistant values and resolutions.

The hand high-level API 450 supports a hierarchical collision searching scheme for real-time collision by loading virtual graphic model data as a scenegraph structure 450.

The scenegraph module 451 receives hand tracking information from the hand hardware API 430 and updates a transform matrix for controlling a virtual hand model and virtual environment model based on the received hand tracking information. While controlling the virtual hand model, the measured values of human anatomical finger motions are compensated. The collision processing module performs a real-time collision process and an interaction process between hand motions. In order to improve the immersion sense, collision events between about several million polygon data models and virtual objects are processed in real time. In order to process the mess amount of data models and the real time collision processes, an interested object is discriminated in advance to reduce a calculation time required for real time process, and the hierarchical collision search scheme is used. The graphic of virtual hand model is updated to be closest to real hand motion of a user based on the collision process information.

As described above, the hand interface glove using miniaturized absolute position sensors and the hand interface system using the same according to the present invention accurately tracks the hand motions of a user using miniaturized absolute position sensors, and synchronizes the three-dimensional virtual hand model in the cyberspace in real time based on the tracked hand motions so as to allow the user to delicately interact with objects in the cyberspace. Therefore, the hand interface glove using miniaturized absolute position sensors and the hand interface system using the same according to the present invention can provide a natural and intuitive hand interface in a virtual environment such as virtual criticism and virtual product manufacturing process, which are required by various industrial fields.

Also, the hand interface glove using miniaturized absolute position sensors and the hand interface system using the same according to the present invention synchronizes the virtual hand model in the cyberspace with the motions of user's fingers based on the absolute positions of the finger joints. Therefore, it requires simple compensating operation according to user's body size.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A hand interface glove using miniaturized absolute position sensors comprising:
a glove unit formed in a shape of a hand to be worn by a hand;
a sensor unit for sensing analog signals representing absolute positions of finger joints, which change according to motions made by the finger joints, by disposing a plurality of miniaturized absolute sensors tracking the absolute positions of finger joints at predetermined positions of the glove unit corresponding to finger joints; and
a data collecting unit for receiving the sensed analog signals from the sensing unit, transforming the analog signals to digital signals through amplifying and filtering the received analog signals, and outputting the digital signals.

2. The hand interface glove of claim 1, wherein the miniaturized absolute position sensors sense the absolute positions of finger joints by detecting variation of a length of a fine wire that is inserted into an embedded coil, where the length of fine wire varies according to the absolute position of finger joint.

3. The hand interface glove of claim 1, wherein the miniaturized absolute position sensors are disposed corresponding to second and third finger joints of each finger.

4. The hand interface glove of claim 1, wherein the miniaturized absolute position sensors are attachable/detachable to/from a surface of the glove unit.

5. A hand interface system using miniaturized absolute position sensors comprising:
a hand interface hardware for sensing absolute position signals of finger joints by disposing miniaturized absolute position sensors sensing absolute positions of finger joints at predetermined positions of a glove worn by a hand corresponding to finger joints, and transferring the sensed absolute position signals; and
a hand interface software for controlling a motion of a virtual hand model by calculating an angle of each finger joint using the sensed absolute position signals of finger joints transferred from the hand interface hardware, and controlling interaction between the virtual hand model and objects in a virtual environment.

6. The hand interface system of claim 5, wherein the miniaturized absolute position sensors sense the absolute positions of finger joints by detecting variation of a length of a fine wire that is inserted into an embedded coil, where the length of fine wire varies according to the absolute position of finger joint.

7. The hand interface system of claim 5, wherein the hand interface hardware includes a data collecting unit for transforming the sensed absolute position signals to digital signals of each finger joint.

8. The hand interface system of claim 5, wherein the hand interface software includes:
a hand interface management unit for storing a maximum voltage and a minimum voltage of each finger joint, and sensing joint angles of a user and compensating variation of displacement distance which varies according to a size of user's body using the stored maximum and minimum voltages; and
a hand interface API for controlling motions of a virtual hand model by calculating joint angles of each finger joint using the transferred absolute position signals of each finger joint, and controlling interaction between the virtual hand model and objects in a virtual environment.

9. The hand interface system of claim 8, wherein the hand interface management unit compensates the variation of displacement distance through two simple hand motions that set the maximum and minimum voltages of each finger joint.

10. The hand interface system of claim 9, wherein the two simple hand motions are for accurately measuring the displacement distance of each finger, and the two simple hand motions includes one motion that making a fist with a thumb stretched and the other motion that spreading out fingers with a thumb bended.

11. The hand interface system of claim 9, wherein a user compensates the variation of displacement distance using the hand interface management unit by directly comparing angles of finger joints using a virtual hand model that expresses smooth finger joints through applying a variable skin transforming scheme.

12. The hand interface system of claim 8, wherein the virtual hand model of the hand interface API is interacted with objects in the virtual environment through processing collisions between the virtual hand mode and the object in the virtual environment.

13. The hand interface system of claim 12, wherein the collisions are processed by calculating events of collision between several million polygon data virtual hand models and the object in the virtual environment.

14. The hand interface system of claim 12, wherein the collisions are processed through hierarchical collision searching scheme.
